(19) United States
(12) Patent Application Publication
(10) Pub. No.: US 2023/0136805 A1
(43) Pub. Date: May 4, 2023

(54) DYNAMIC EXECUTION OF DISTRIBUTED RECORDS BASED ON TRIGGER CONDITIONS

(71) Applicant: PAYPAL, INC., San Jose, CA (US)

(72) Inventor: Antony Amalraj Morais, Chennai (IN)

(73) Assignee: PAYPAL, INC.

(21) Appl. No.: 17/514,344

(22) Filed: Oct. 29, 2021

(51) Int. Cl. G06Q 40/04; G06F 16/27; G06Q 20/40

(52) U.S. Cl. CPC G06Q 40/04; G06F 16/27; G06Q 20/401; G06Q 2220/00

(57) ABSTRACT

There are provided systems and methods for dynamic execution of distributed records based on trigger conditions. A service provider may provide operations for dynamic execution of smart contracts that are recorded to records of a distributed ledger for a blockchain. The smart contracts include trigger conditions that cause automatic execution of the smart contracts when met, such as when an exchange rate is met or exceeded for converting funds from a currency to another currency. The smart contracts include wait times for monitoring the exchange rate until the smart contracts end. A blockchain oracle serves as a secure middleware application that may monitor live exchange data while pushing data to the blockchain to determine if a smart contract is to be executed. If met, the smart contracts may be executed based on the user input. If not, it will either be voided or executed at the latest exchange rate.

### TECHNICAL FIELD

The present application generally relates to blockchain protocols and distributed blockchain records, and more particularly to providing trigger conditions for variable and dynamic execution of smart contracts in the distributed blockchain records.

### BACKGROUND

Users may utilize online electronic transaction processors to process transactions between end users as well as exchange and transfer funds. This may include cross-border transactions that occur between users in different locations and having different currencies. For example, a buyer in the United States may purchase products, services, or items from a seller overseas, such as in China, where currency is required to be converted between U.S. dollars (USD) to Chinese Yuan (CNY). Other customers and/or merchants that utilize a transaction processor and electronic transaction processing platform may want to transfer money to other users in different countries and/or in different currencies or may wish to exchange one currency into another currency (e.g., if travelling or using the currency in a specific country). However, when performing these currency exchanges, the users and/or merchants are locked into a specific exchange rate at the time of the transaction and/or transfer. This may be an unfavorable rate and may cause loss on behalf of the users and/or merchants. Thus, it is desirable to offset and/or reduce this waste when processing transactions and/or transfers in different currencies.

### BRIEF DESCRIPTION OF THE DRAWINGS

FIG. 1 is a block diagram of a networked system suitable for implementing the processes described herein, according to an embodiment;

FIG. 2 is exemplary system environment for dynamically executing smart contracts recorded on a blockchain for different trigger conditions, according to an embodiment;

FIG. 3A is exemplary chart of threshold trigger conditions used to execute a smart contract over a time period, according to an embodiment;

FIG. 3B is exemplary chart of a weighted moving average over a time period for threshold trigger conditions used to execute a smart contract, according to an embodiment;

FIG. 3C is exemplary chart of a percentage change with respect to a previous day over a time period for threshold trigger conditions used to execute a smart contract, according to an embodiment;

FIG. 4 is a flowchart for dynamic execution of distributed records based on trigger conditions, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for dynamic execution of distributed records based on trigger conditions. Systems suitable for practicing methods of the present disclosure are also provided.

A user may utilize a digital account and/or wallet to process payments through smart contracts that use a blockchain protocol and network, where the smart contracts are dynamically executed based on trigger conditions and/or wait times. Smart contracts may correspond to digital contracts that correspond to programs stored on a blockchain that automatically run and execute in response to specific conditions being met. For example, a smart contract may correspond to a computer program and/or transaction protocol to automatically execute without requiring active input or execution request by a user when the corresponding terms, trigger conditions, and the like being detected and/or met. A user may make a payment to another user or otherwise transfer currency between digital wallets, nodes, or users, which may include fiat and/or digital currency in a particular type of currency. When processing these transactions and/or currencies, the transactions and/or transfers may occur in a first base currency that is exchanged or converted to a different currency that is paid to the user (e.g., when exchanging the user's funds) or another user or merchant (e.g., when paying for products, services, and/or items in a transaction). Conventionally, the user may accept a current exchange rate that is used to exchange the currency between the currency types and/or may accept a currently set fee for the currency exchange. However, in various embodiments described herein, one or more of the users, customers, or merchants in the transaction may instead cause a smart contract to be generated and persisted to a blockchain for dynamic execution at a later time based on trigger conditions and/or conversion rates. This allows the conversion of the currency between currency types to be dynamically executed based on an acceptable conversion rate and/or after a period of time. Thus, the user may receive a more preferred conversion rate and does not need to continually monitor the conversion rate and actively request execution of the transaction when the conversion rate is at a desired rate.

When persisting the transaction to a digital ledger associated with the blockchain protocol, a smart contract may be generated that corresponds to a digital contract having computer coded instructions to execute operations to process a transaction automatically and dynamically. These coded instructions may include a trigger condition, such as a currency exchange rate, fee for currency exchange, and other costs and/or rates associated with exchanging currency from one currency type or standard to another. The smart contract and/or trigger condition(s) may also have an expiration time period or wait time where the smart contract is valid and exchange rates, fees, and costs associated with currency exchange are monitored for if the trigger condition(s) are met. At the end of the wait time, the smart contract may be automatically executed at a current exchange rate and/or may be voided and the funds returned to a user. Determination of whether to automatically execute or void the smart contract based on the desired action chosen by the user.

Multiple smart contracts may be executed concurrently and/or combined in order to execute the corresponding programs and process currency exchange or conversion transactions at the same time. The smart contracts may be combined based on having the same or similar trigger conditions, such as the requested exchange rate. For example, two or more smart contracts may be detected as having the same trigger condition for a particular exchange rate and may either be executed concurrently when that condition is met and/or combined into a smart contract that is monitored, which may be more efficient for processing than monitoring two individual smart contracts. A plurality of smart contracts may be persisted in a distributed manner through the use of a blockchain protocol and “blocks” or digital records in a distributed digital ledger for a blockchain. As such, in one embodiment, a blockchain protocol and network provides a distributed ledger to record and cause execution of smart contracts based on the whether the trigger conditions are met, or the wait time expires. A blockchain oracle may serve as secure middleware to facilitate communications and data exchanges with the blockchain and smart contracts and one or more off-chain systems that include exchange rate data for execution of the smart contracts.

For example, a user may wish to process a transaction, such as for a payment to another user or a transfer of currency, including fiat currency, digital currency, cryptocurrency, video game currency, and the like. A user may pay for one or more currency transactions using a digital wallet or other account with an online service provider or transaction processor (e.g., PayPal®). An account may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The account and/or digital wallet may be loaded with currency or currency may otherwise be added to the account or digital wallet. The application or website of the service provider, such as PayPal® or other online payment provider, may provide payments and the other transaction processing services via the account and/or digital wallet.

Once the account and/or digital wallet of the user is established, the user may utilize the account via one or more computing devices, such as a personal computer, tablet computer, mobile smart phone, or the like. The user may engage in one or more transactions with a recipient, such as a recipient account and/or digital wallet that may receive an amount of currency. When generating a transaction, a user may designate the recipient and an amount of currency to transfer to the recipient, which may also be the same user when exchanging the user's funds and currency. A currency exchange transaction may be based on a remittance for a smart exchange of funds from one currency to another currency, such as when a user would like to convert an amount of funds that the user would retain after the transaction. However, the currency exchange transaction may also be based on a checkout smart contract that is paid in one currency by a buyer and provided to a seller in another currency. Such a transaction may correspond to a cross-border transaction, for example, one engaged in by transaction participants in different countries (e.g., paid by a buyer in USD and provided to a seller in Euros). Thus, different types of smart contracts may be generated for different currency exchange transactions. In this regard, the amount of funds for the transaction may be maintained in an account, escrow, or the like for the service provider and/or online transaction processor that generates and/or processes the smart contracts.

When designating the currency, all or a portion of the currency may be designated for conversion and/or exchange in a dynamic manner based on the trigger condition(s) and/or wait time(s) so that a more favorable exchange rate may be received. This may therefore designate that an exchange rate, fee, or other cost is required to be met or reached before the currency is processed in a transaction and exchanged with another user in a different currency. A process is then engaged to generate a smart contract that is persisted in a record on the blockchain and distributed network for the amount of currency to exchange or convert to another type of currency.

Once completed and/or digitally signed, the account and/or digital wallet may then broadcast the digitally signed currency exchange transaction over the layer one or layer two network for the blockchain protocol used by the smart contract for currency exchange. Broadcasting may further cause the smart contract for the currency transaction on the blockchain network to be finalized and recorded on the blockchain, such as in one or more blockchain records or blocks. This allows the currency transaction on the blockchain network to be processed and monitored for whether trigger condition(s) and/or event(s) are met or whether a wait time expires. In this regard, when a smart contract is broadcasted, it may be recorded in a blockchain distributed record by broadcasting over different distributed nodes and/or computing devices for the blockchain's distributed digital ledger and/or records. These blockchain nodes or participants may correspond to devices, servers, and/or systems that record the digital records for the smart contracts and allow for persisting the digital records over the distributed nodes. Each block may include a cryptographic hash or other record of one or more previous blocks to validate the new block and the previous block(s), a timestamp, and the data for the smart contract(s). Further, the nodes allow for the distributed records to be confirmed and validated in order to prevent or resist modification using the peer-to-peer or other network for the blockchain.

Thereafter, a smart contract recorded on the blockchain may be monitored over the time period and/or until the expiration time set for the currency conversion transaction to determine if the trigger condition is met and the amount of funds should be converted from the first currency to the second currency. The monitoring may be performed through a blockchain oracle and one or more operations to monitor and/or execute currency exchange transactions. Thus, after persisting the smart contract on the blockchain, the monitoring operations may utilize a blockchain oracle that interfaces with an external system to determine live, real-time, near real-time, and/or dynamic data. The data may be associated with current and/or past exchange rates for different currencies including the first currency and the second currency that indicates an exchange rate between those currencies (e.g., an amount of a currency's value in another currency). Thus, the external system may correspond to a live currency exchange and/or exchange rate service that may be used to determine exchange rates at different time periods (e.g., continuously and/or intermittently at periodic time intervals).

The blockchain oracle may correspond to a blockchain middleware application having an on-chain component and an off-chain component operating simultaneously to establish a blockchain connection to the blockchain and send the blockchain data to the live currency exchange or other external system. The blockchain oracle's on-chain component may further broadcast data to the blockchain and/or extract blockchain data for the blockchain, while the on-chain component may process requests, retrieve and/or format external data for the blockchain, send blockchain data to external systems and/or perform other actions that may allow the monitoring operations to determine data for the live currency exchange and/or smart contract on the blockchain (e.g., performing computations associated with currency exchange rates and/or trigger conditions). Thus, the blockchain oracle may include secure blockchain operations and may further interact with multiple external systems, such as those that may have different exchange rates.

In this regard, the blockchain oracle may pull data from the external system for the live currency exchange or other data service and may push data to a distributed digital ledger and/or monitoring operations for the blockchain and/or smart contract. The data may include the exchange rates and may also include additional data for exchange rates. For example, in addition to an exchange rate (e.g., an amount, percentage, ratio, or the like, such as 0.87USD=1Euro), the additional data for exchange rates may include moving averages over a time period or for a certain time in the past, such as a five-day moving average. The additional data may also correspond to a weighted moving average, a percentage change over a time period or compared to a previous time period (e.g., a percentage change compared to a previous day), or the like.

When monitoring the exchange rate and additional data, the monitoring operations and/or blockchain oracle may determine whether to execute the smart contract by performing and/or processing a currency exchange transaction for a current and/or selected exchange rate. The smart contract may be executed, and the currency exchange transaction processed, if the first currency's exchange rate to the second currency meets or hits the trigger condition and requested exchange rate prior to or at the expiration of the smart contract's wait time or validity period. However, the smart contract may also be executed in response to detecting a certain pattern. For example, if the exchange rate, moving average, weighted moving average, change with respect to a previous time period, and/or a percentage change in exchange rate with respect to a previous day or other previous time period indicates a certain movement or pattern in the exchange rate, the smart contract may instead be executed, and the amount of funds exchanged between the currencies. This may occur if the exchange rate falls over a threshold amount or percentage, or if the exchange rate indicates a different negative trend or pattern. This negative trend may include detecting the exchange rate initially increases by an amount or percentage, but then falling and indicating a negative pattern. The negative trend may instead include lowering the trigger condition.

In contrast, the trigger condition may be raised if the exchange rate increases a threshold amount or percentage to indicate a positive trend or pattern. Further, if the trigger condition is increased or raised, but then a negative pattern occurs, the trigger condition may be reset to the lower value or otherwise lowered. In some embodiments, the smart contract may be one of a plurality of smart contracts for an entire amount of funds to be exchanged between currencies, each having a separate portion of the entire amount, which may have different and/or progressive exchange rates (e.g., one for 0.85, one for 0.87, and one for 0.90 of an exchange rate of USD to Euros). The smart contract may also be progressive to have multiple trigger conditions that are similarly progressive for portions of the entire amount of funds and at different exchange rates. This may allow the recipient of the funds after exchange to receive different exchange rates that may be progressively more favorable. Trigger conditions may be set by any party to the transaction. Trigger conditions may also be suggested by the system to the user based on user data and the transaction, such as amount of the transaction (where a lower exchange rate may be more important to the user than a smaller amount transaction), importance of the transaction to the user (e.g., setting trigger conditions that are more likely to be met so that the user does not lose the transaction or have the smart contract and the transaction voided).

Thereafter, the smart contract may be executed or voided. As previously discussed, the smart contract may be executed if the exchange rate meets the trigger, which may process a currency exchange transaction to convert the amount of funds set for the smart contract from the first currency to the second currency. However, if no trigger condition is met by the expiration of the wait time and/or validity period of the smart contract, then the service provider, transaction processor, and/or other monitoring operations may determine whether to void the smart contract and/or perform another action. Voiding the smart contract may cause the smart contract to be ended and no currency exchange transaction to be processed.

However, other actions may include automatic execution of the smart contract, pinging one or more users associated with the smart contract to determine whether to execute the smart contract and exchange the funds between currencies or generate new smart contract for a further wait time and desired exchange rate, or and/or ping the user(s) of whether to void the smart contract and return funds to the initial user providing the funds. If voided and the funds are to be returned, the user for a remittance smart contract may receive the initial funds, as well as any interest and/or fees. With a checkout and/or payment smart contract for a transaction processed between two users (e.g., a buyer and seller, such as in a cross-border transaction), the smart contract may be canceled, and the transaction may not be processed between the two users. For example, the transaction may be dependent on the smart contract being executed. In other embodiments, the seller may receive the amount of funds in the currency paid by the buyer for later conversion or the amount of funds may be automatically converted at a current exchange rate.

In this manner, smart contracts using blockchain protocols may be used for faster and more coordinated electronic transaction processing of currency exchange transactions. For example, a blockchain and persisted digital records for smart contracts may be used with a secure middleware application to automatically monitor smart contracts and exchange rates. This allows for automated execution of the smart contracts on detection of a trigger condition, which does not require user inputs and active monitoring for exchange rate values. The automated execution reduces the user inputs and provides faster and secure processing of the smart contracts with an online service provider and/or transaction processor.

Further, smart contracts for currency exchange may be used for different real-world, virtual, augmented or virtual reality, and/or metaverse applications for interactions between different users. Currency exchanges may assist in providing cross-border transactions facilitated over a metaverse in these different environments and may allow for monitoring and executing of currency exchange contracts intelligently and automatically to facilitate user interactions. The interactions may be broadcast over networks and communications for this metaverse, which may link different environments and allow automatic monitoring and execution of smart contracts between different computing environments and networks.

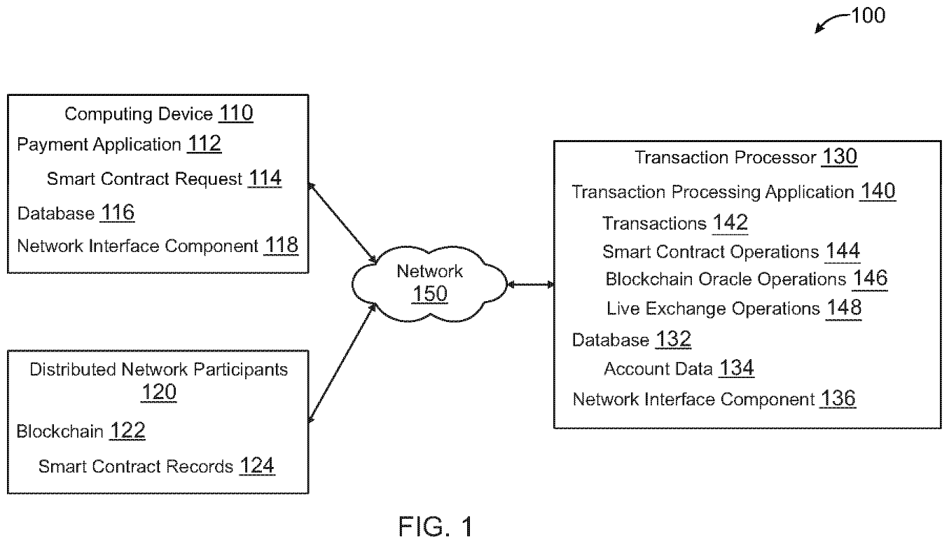

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways, and that the operations performed, and/or the services provided by such devices and/or servers, may be combined or separated for a given embodiment and may be performed by a greater number or fewer number of devices and/or servers. One or more devices and/or servers may be operated and/or maintained by the same or different entities.

System 100 includes a computing device 110, distributed network participants 120, and a transaction processor 130 in communication over a network 150. Computing device 110 may be used to process payments, such as through a payment platform, application, and/or application extension, which may be facilitated through digital accounts and wallets that allow for establishing smart contracts on a blockchain for currency conversion or exchange transaction processing through distributed network participants 120. During currency exchange transaction processing, distributed network participants 120 may be in communication with a secure middleware application and/or operations that monitor data for smart contracts to determine whether to execute the smart contracts based on currency exchange rates.

Computing device 110, distributed network participants 120, and transaction processor 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Computing device 110 may be implemented using any appropriate hardware and software configured for wired and/or wireless communication with distributed network participants 120 and/or transaction processor 130 for processing payments and transactions for currency exchanges between two or more currencies. Computing device 110 may correspond to an individual user, consumer, or merchant that utilizes a peer-to-peer payment network and platform provided by distributed network participants 120 and/or transaction processor 130 to process those transactions. In various embodiments, computing device 110 may be implemented as a personal computer (PC), a smart phone, laptop/tablet computer, wristwatch with appropriate computer hardware resources, other type of wearable computing device, and/or other types of computing devices capable of transmitting and/or receiving data. Although only one computing device is shown, a plurality of computing devices may function similarly.

Computing device 110 of FIG. 1 contains a payment application 112, a database 116, and a network interface component 118. Payment application 112 may correspond to executable processes, procedures, and/or applications with associated hardware. In other embodiments, computing device 110 may include additional or different software as required.

Payment application 112 may correspond to one or more processes to execute modules and associated devices of computing device 110 to provide a convenient interface to permit a user of computing device 110 to enter, view, and/or process currency exchange transactions, such as by establishing a smart contract request 112 to generate a smart contract for currency exchange. In this regard, payment application 112 may correspond to specialized hardware and/or software utilized by computing device 110 that may provide transaction processing for currency exchanges, including remittance smart contracts for remitting an amount of funds to a user in a currency when the used initially establishes the amount of funds in another currency. In further embodiments, the currency exchange transaction may be to request a payment to another user in a currency, such as a seller, when a buyer provides the amount of funds in another currency. Establishment of smart contract request 114 may be done through a user interface enabling the user to enter and/or view an amount of funds, the requested currency exchange rates, amount of time, and other trigger conditions for processing in a transaction to exchange the amount of funds between different currencies. This may be based on a transaction generated by payment application 112 using a merchant website or may be done with an application for a remittance smart contract. For example, payment application 112 may utilize an amount of currency to provide remittances and/or payments to recipients. Additionally, payment application 112 may utilize a digital wallet associated with currency exchange processing based on smart contract request 114. Payment application 112 may also be used to receive a receipt or other information based on transaction processing.

Smart contract request 114 may establish a smart contract on a blockchain as a block record or the like for a distributed ledger over blockchain nodes or devices. Payment application 112 may be integrated with distributed network participants 120 to establish a smart contract and broadcast for recording and persisting with the blockchain. In this regard, payments and remittances for currency exchange transactions may be resolved using distributed network participants 120 and a blockchain oracle or secure middleware application. In various embodiments, payment application 112 may correspond to a general browser application configured to retrieve, present, and communicate information over the Internet (e.g., utilize resources on the World Wide Web) or a private network. For example, payment application 112 may provide a web browser, which may send and receive information over network 150, including retrieving website information, presenting the website information to the user, and/or communicating information to the website, including payment information for the transaction. However, in other embodiments, payment application 112 may include a dedicated application of transaction processor 130 or other entity (e.g., a merchant), which may be configured to assist in processing transactions, such as a mobile application on a mobile device.

Computing device 110 may further include database 116 which may include, for example, identifiers such as operating system registry entries, cookies associated with payment application 112 and/or other applications, identifiers associated with hardware of computing device 110, or other appropriate identifiers. Identifiers in database 116 may be used by a payment/service provider to associate computing device 110 with a particular account maintained by the payment/service provider. Database 116 may also further store received transaction data and/or data for use of smart contracts and/or blockchains for processing currency exchanges.

Computing device 110 includes at least one network interface component 118 adapted to communicate with distributed network participants 120 and/or transaction processor 130 over network 150. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Distributed network participants 120 may correspond to or be associated with a blockchain 122 and/or payment networks, which may be used to establish and process smart contract records 124. For example, distributed network participants 120 may correspond to networks of devices that may communicate to share, update, and maintain a distributed ledger for smart contracts and/or transaction processing and maintain smart contract records 124 on blockchain 122 for the currency exchanges that are being processed in transactions. In this regard, distributed network participants 120 may include transaction participants and miners, where transaction participants may process transactions to exchange and/or pay amounts of funds. When a smart contract and/or other transaction is generated, a record may be required to be generated, updated, and maintained on blockchain 122, which requires a level one network and/or level two network and allows miners to validate and broadcast the transactions and records over the distributed ledger for the blockchain. The level one network may correspond to a base network where transactions are persisted in block records on blockchain 122 when processed, such as a Bitcoin network and protocol. Further, distributed network participants 120 may include a layer two network, such as a Lightning network, that may reside on top of processing for the layer one network for the allow for additional data broadcasting, recording, monitoring, and/or processing. These networks may be used for maintaining and/or monitoring smart contract records 124.

Transaction processor 130 may be maintained, for example, by an online service provider, which may provide operations for smart contracts for transactions processed for exchanging currencies from one type to another for an amount of funds. In such embodiments, transaction processor 130 may interface with the layer one and layer two networks for blockchains that may be used to record and monitor smart contracts and exchange rates. Transaction processor 130 includes one or more processing applications which may be configured to interact with computing device 110 for smart contracts for currency exchange transactions and payments recorded in block records distributed over and on distributed network participants 120. In one example, transaction processor 130 may be provided by PAYPAL®, Inc. of San Jose, Calif., USA. However, in other embodiments, transaction processor 130 may be maintained by or include another type of service provider.

Transaction processor 130 of FIG. 1 includes a transaction processing application 140, a database 132, and a network interface component 136. Transaction processing application 140 may correspond to executable processes, procedures, and/or applications with associated hardware. In other embodiments, transaction processor 130 may include additional or different modules having specialized hardware and/or software as required.

Transaction processing application 140 may correspond to one or more processes to execute software using associated hardware components of transaction processor 130 to establish smart contracts and/or process a transaction for an exchange of an amount of funds from one currency to another currency. In some embodiments, transaction processing application 140 may be used by a user associated with computing device 110 to establish a payment account and/or digital wallet, which may be used to process currency exchange transactions. In various embodiments, an amount of funds in one or more currencies may be established for the account. A digital token for the wallet may be used to send and process payments, for example, through an interface provided by transaction processor 130. The digital wallet may be accessed and/or used through a browser application/extension and/or dedicated payment application executed by computing device 110 and engage in currency exchange transaction processing, such as using smart contracts established for a blockchain maintained by computing device 110 and/or distributed network participants 120. In various embodiments, transaction processing application 140 may be used to generate transactions 142 based on smart contracts broadcast over distributed network participants 120 for persisting in a blockchain record, such as smart contract records 124.

In this regard, computing device 110 may establish one or more of transactions 142, which may correspond to remittance currency exchange requests and smart contracts to remit to a user an amount of funds in one or more different currencies than what was initially provided for the amount of funds. In other embodiments, one or more of transactions 142 may correspond to checkout or payment currency exchange requests and smart contracts where an amount of funds is to be paid to a seller, merchant, or other entity by a buyer, consumer, or similar entity in a currency that is different than the currency paid in for the amount of funds. When generating smart contract records 124 for these currency exchange transactions, smart contract operations 144 may be executed to generate one or more smart contracts. The smart contracts may be established for an amount of funds, which may be held by transaction processor 130 and/or established with each smart contract.

Smart contract operations 144 may correspond to one or more executable operations and/or processes that may be used to process a request to establish a smart contract for a currency exchange or conversation and generate the corresponding smart contract. This may include determining data for the request, such as the amount of funds and the currency of those funds, the desired currency for conversion of those funds, trigger conditions, and wait times. Once generated, smart contract operations 144 may also broadcast or otherwise persist the smart contract to the corresponding blockchain. When receiving the amount of funds and the desired currency for conversion of those funds, smart contracts may also be established for mixed currency types, such as from fiat or physical currency to cryptocurrency or other digital and/or decentralized currency. In this regard, smart contracts may designate the currency conversion rates on different exchanges for different types of currencies, such as foreign exchange systems and/or cryptocurrency exchanges and purchase/selling platforms.

Smart contract operations 144 may generate one or more smart contracts, which each may have an amount of funds. A single smart contract may be established by smart contract operations 144 for a currency exchange transaction, which may have one or more trigger conditions. The trigger conditions may correspond to a requested exchange rate, amount, or conversion percentage, as well as an amount of time until either the smart contract is automatically executed, or the funds are returned to the remittance party, the buyer, or the seller. The trigger condition may also include patterns or trends in currency exchange rates, such as changes in moving averages, previous time period rate changes, and the like. Additionally, multiple trigger conditions, such as different exchange rates, patterns or trends in exchange rates and changes, and/or amounts of time for wait times may be set for a single smart contract for an amount of funds to exchange portions of the amount of funds, or instead multiple smart contracts may be established for the portions of the amount of funds and the different exchange rates, trends, and/or amounts of times.

Smart contract operations 144 may the broadcast and/or record the smart contract(s) to blockchain 122 via distributed network participants 120. Once recorded, blockchain oracle operations 146 may be used to exchange data and monitor a conversion rate with live exchange operations 148, such as those exchange rates that may be available with a live currency exchange. Blockchain oracle operations 146 may correspond to a secure middleware application and may be used to interface with blockchain 122 for monitoring smart contracts 124 based on exchange rate data from live exchange operations 148. Blockchain oracle operation 146 may monitor exchange rates with different types of currency exchange systems. This may also include values of different currencies in another currency and/or type of currency. For example, when exchanging USD to cryptocurrency, or vice versa, the smart contracts may monitor the value of the cryptocurrency in USD or other fiat currency and may execute a purchase or sale transaction of the cryptocurrency. With fiat currencies, a foreign exchange system may be monitored for the exchange rate between different fiat currencies.

If a trigger condition is met, a currency exchange transaction may be processed to execute the corresponding smart contract. However, if a wait time or expiration time occurs or expires, then transaction processing application 140 may determine whether to void the smart contract, generate a new smart contract, and/or automatically execute the smart contract at a current exchange rate. Additional triggers may also void a contract, which may be set by the user requesting the currency exchange and/or determined by transaction processor 130. For example, a location-based trigger may void a smart contract if a user is detected as in and/or moving to a specific location (e.g., a country), such as one associated with the base currency the funds are provided in. This may occur so that the user may retain the proper currency for the user's location. Further, if multiple matching transactions are detected at once, one or more smart contracts may be voided to avoid duplication of transactions and/or fraud. Transaction processing application 140 may further execute a privacy and/or risk detection system in order to determine whether a smart contract should be voided based on detected risk, user privacy, and/or potential fraud.

Additionally, transaction processor 130 includes database 136. Database 136 may store various identifiers associated with computing device 110. Database 132 may also store account data, including payment instruments and authentication credentials, as well as transaction processing histories and data for processed transactions. Account data 134 stored by database 132 may include data for accounts used to generate smart contracts for currency exchange transactions. Database 136 may further be used to store data for blockchain 122 and for use in monitoring and/or executing smart contract records 124. This may include identifiers and/or other data for monitoring smart contract records 124 and/or information associated with currency exchange rates.

In various embodiments, transaction processor 130 includes at least one network interface component 136 adapted to communicate computing device 110, distributed network participants 120, and/or another device/server for a merchant over network 150. In various embodiments, network interface component 136 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

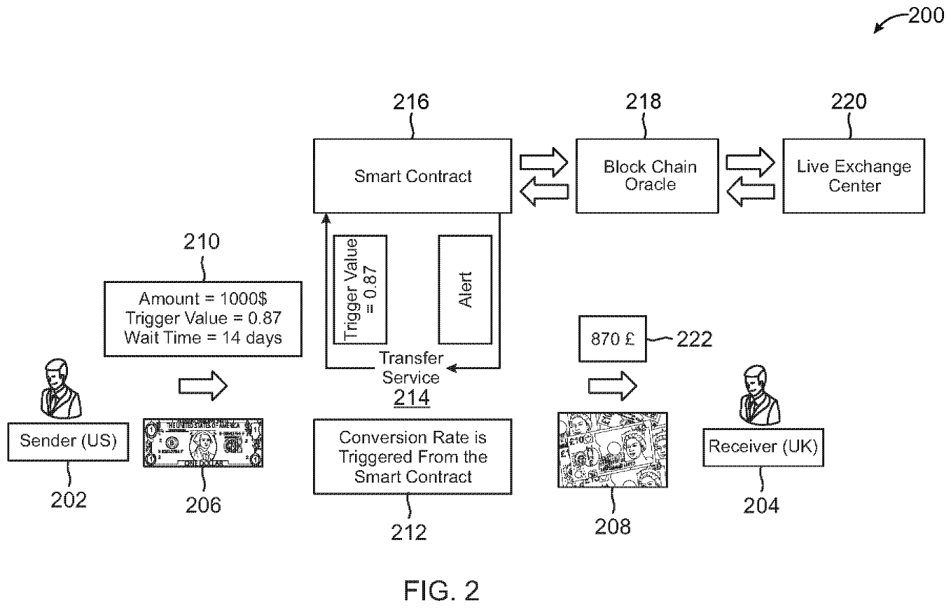

FIG. 2 is exemplary system environment 200 for dynamically executing smart contracts recorded on a blockchain for different trigger conditions, according to an embodiment. System environment 200 includes smart contracts on a blockchain that are dynamically executed for variable trigger conditions, such as by transaction processor 130 based on smart contracts established by computing device 110 with distributed network participants 120 discussed in reference to system 100 of FIG. 1. System environment 200 may correspond to a system having interactions for registering, monitoring, and executing smart contracts for currency exchange transactions dynamically based on exchange or conversion rates between currencies.

In system environment 200, a sender 202 may desire to send an amount of funds, such as for a transfer, payment, transaction, or the like to a receiver 204 in another country and/or where the sender and receiver 204 may utilize or want different currencies. This may correspond to a cross-border transaction, but other transfers may also be included including those between friends or family. Further, sender 202 and receiver 204 may be the same person or entity in some embodiments, such as for remittance contracts where a user, company, organization, or the like may want to convert funds between currencies and receive back the amount of funds in a different currency.

In this regard, an amount of funds, money, or the like (including assets such as contracts, stocks, derivatives, and/or virtual assets including virtual and/or cryptocurrency) may be provided in a first currency 206, where the amount of funds is to be returned in a second currency 208. When providing the amount of funds in first currency 206, smart contract parameters 210 may be provided that are used to generate, monitor, and/or execute the smart contract. For example, smart contract parameters 210 include the amount of funds for $1,000. The smart contract parameters 210 further include a trigger value for an exchange rate of 0.87 for exchanging or converting first currency 206 to second currency 208. This trigger value allows for dynamic execution of the smart contract on detection of the trigger value being met. The trigger value may also correspond to a value of a particular currency, such as a cryptocurrency that may be purchased using funds in first currency 206. Thus, the trigger value may be monitored by a cryptocurrency exchange platform, wallet provider, and/or seller, which may cause a purchase or sale of cryptocurrency.

The trigger value may also come with additional trigger conditions. For example, the trigger conditions may include patterns or trends in moving averages, percentage changes over a previous time periods, and the like, which may be used to determine when to dynamically execute a smart contract. Further, a wait time, or a time period until expiration of the smart contract, is set. The wait time may correspond to a time period to monitor the exchange rate for dynamic execution of the smart contract. After the wait time, the smart contract may be voided, and the funds returned to sender 202. The smart contract may also be voided based on additional triggers or information for the smart contract. For example, the smart contract may be voided if fraud is detected, or a risk score meets or exceeds a threshold risk. The smart contract may also be voided based on detecting a change in location of the user and/or if duplicate transactions of a user are detected. However, the smart contract may instead be automatically executed at the expiration of the wait time and the funds may be paid in second currency 208 to receiver 204, or instead the funds in first currency 206 may be provided to receiver 204. Further, sender 202 and/or receiver 204 may be given the option to generate a new smart contract.

Additionally, as the smart contract gets closer to expiration of the wait time, sender and/or receiver 204 may be given an option to execute at a different trigger value and/or the smart contract may be automatically executed for a “best” or highest detected trigger value over a previous time period. Further, multiple different levels or exchange rates may be established for a smart contract, or multiple smart contracts may be generated for different exchange rates and/or wait times. A user may select multiple exchange rates or levels, such as to convert $500 of $1,000 at an exchange rate of 0.87 and converting the other $500 at an exchange rate of 0.90. The user may also request that a portion is converted if the exchange rate rises by 5% and another portion is converted if the exchange rate rises by 10%. This may allow sender 204 to progressively receive portions of the amount of funds in second currency 208, thereby providing a scalable exchange policy. Smart contracts for different users but the same trigger value or condition may be combined into a single smart contract and/or executed in the same processing action and/or currency exchange transaction. This may allow for conservation of processing resources and faster execution of the smart contracts at the correspond trigger value, which may be of most importance.

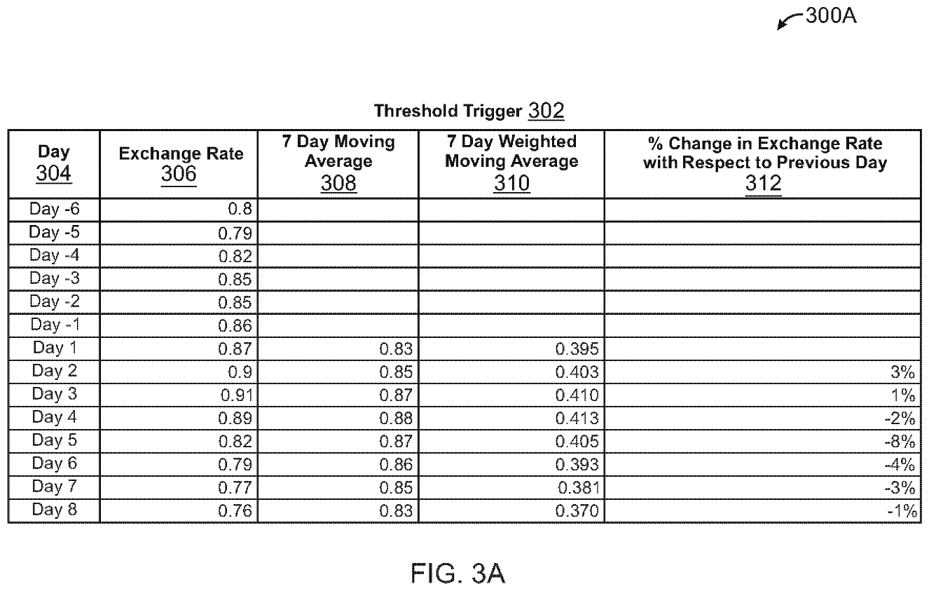

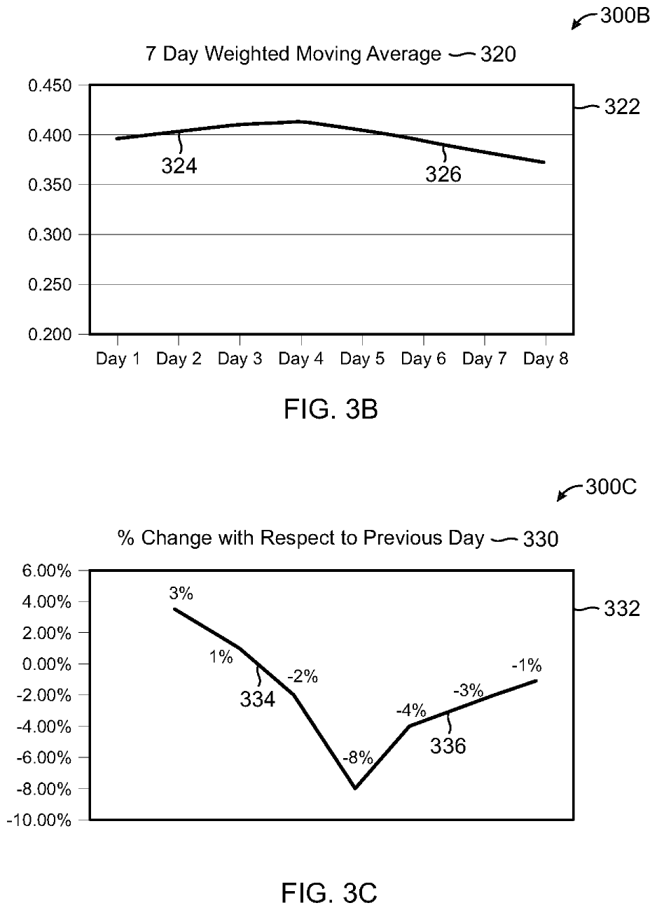

Thereafter, a smart contract rule 212 is provided with smart contract parameter 210 to a transfer service 214 in order for generation of a smart contract 216. Transfer server 214 may correspond to a computing service, platform, and/or application/website of a service provider or transaction processor, such as transaction processor 130 in system 100. Transfer service 214 generates smart contract 216 having the trigger value of 0.87 and establishes alert operations to notify transfer service 214 if a trigger condition is met, exceeded, or otherwise satisfied. This may further include determine additional trigger conditions based on remaining wait time and/or trends in exchange rates are satisfied to execute smart contract 216 at a different exchange rate than 0.87. For example, different moving averages or percentage changes over time in the exchange rate, remaining wait time, and the like may be used to dynamically execute smart contract 216 at a different exchange rate than that initially set with smart contract parameters 210. These may be set by sender 202 and/or receiver 204 or may be intelligently decided based on parameters set or known for sender 202 and/or receiver 204. These variable trigger conditions are discussed in more detail with regard to FIGS. 3A-3C.

Once transfer service 214 generates smart contract 216, smart contract 216 is broadcasted over distributed computing nodes, devices, servers, and the like of a blockchain for a blockchain protocol associated with recording and persisting smart contract 214 in a distributed ledger and/or records of the blockchain. This may correspond to Ethereum or other smart contract blockchain protocol and network. In order to dynamically execute smart contract 216, a blockchain oracle 218 may be used, which may correspond to a secure middleware application. Blockchain oracle 218 may include operations for determining parameters for smart contract 214, including the trigger condition(s) and/or wait time, and monitor for these conditions using a live exchange center 220. Live exchange center 220 may provide live data for exchange rates and other conversion data between different currencies. Blockchain oracle 218 may therefore monitor different data after persisting smart contract 214 on the blockchain in a record, which may occur live, in real-time or near real-time, and/or at certain time intervals. Live exchange center 220 may provide dynamic data for changing exchange rates of first currency 206 to second currency 208 to blockchain oracle 218.

Blockchain oracle 218 may include an on-chain component and an off-chain component operating simultaneously. Blockchain oracle 218 may establish a blockchain connection to the blockchain and send the blockchain data to live exchange center 220 to determine if a trigger condition is met. In this regard, the on-chain component may broadcast data to the blockchain and/or extract blockchain data for the blockchain, which may correspond to the trigger condition(s) and/or wait time for smart contract 216. The on-chain component may process requests, retrieve and/or format external data for the blockchain, send blockchain data to external systems and/or perform computations associated with currency exchange rates and/or trigger conditions (e.g., those associated with dynamic trigger conditions based on changes in exchange rates and/or remaining wait time).

Thus, blockchain oracle 218 may pull data from live exchange center 220 for the exchange rate and/or may push data to a distributed digital ledger for smart contract 216 for dynamic execution of smart contract 216. In the trigger condition is met within the wait time, a converted amount 222 may be provided to receiver 204 in second currency 208. The converted amount 222 may be based on smart contract parameters 210 and based on executing one or more currency exchange transactions based on smart contract 216. However, if the exchange rate and/or other trigger condition(s) is/are not met, then transfer service 214 may execute one or more additional operations for smart contract 216. This may include voiding smart contract 216, automatically executing smart contract 216 at a current exchange rate, generating a new smart contract for the amount of funds, and/or determining whether to provide the amount of funds to sender 202 and/or receiver 204 in first currency 206 instead of converting to second currency 208.

FIG. 3A is exemplary chart 300a of threshold trigger conditions used to execute a smart contract over a time period, according to an embodiment. Chart 300a may represent additional data used for trigger conditions for smart contract execution for currency exchange transactions. Such data may be used when generating and monitoring a smart contract, such as when computing device 110 interacts with distributed network participants and/or transaction processor 130 discussed in reference to system 100 of FIG. 1. In some embodiments, a 7-day weighted moving average and/or a percentage (%) change in exchange rate with respect to a previous day may be used. Further, other trends and/or available data may also or instead be used.

In chart 300a, a threshold trigger 302 is shown, where threshold trigger 302 may include different data for execution of a smart contract at a variable exchange rate. In this regard, threshold trigger 302 includes a day 304 for each exchange or conversion rate, an exchange rate 306, a 7-day moving average 308, a 7-day weighted moving average 310, and a percentage change 312 in the exchange rate with respect to a previous day. A smart contract may initially be created for a set amount of exchange rate 306. For example, a user setting the smart contract, such as a sender of funds or a receiver of the funds from the sender, may select to have the smart contract executed and the funds converted from a first to a second currency based on a particular rate of 0.91. Thus, the smart contract may be executed on day 3. Additionally, the smart contract may be combined with the same or similar smart contracts (e.g., for the same trigger value or condition) so that smart contracts may be executed in a single operation for multiple users.

However, the blockchain oracle, transaction processor, or other monitoring service and/or operations may view exchange rate 306, 7-day moving average 308, 7-day weighted moving average, and/or percentage change 312 as increasing, and may corresponding increase the value of the trigger condition of 0.91. This may be performed based on a preference for the user with the smart contract, or may be done automatically while guaranteeing the initial trigger condition but allowing the service provider or transaction processor to take a fee or portion of the increased trigger condition if met. However, as exchange rate 306, 7-day moving average 308, 7-day weighted moving average, and/or percentage change 312 proceed with a downward trend from day 4 onward, the initial exchange rate may be reset and/or the smart contract may be automatically executed in order to preserve the highest exchange rate over the wait time.

In other embodiments, the user may establish multiple trigger conditions, which may be based on exchange rate 306, 7-day moving average 308, 7-day weighted moving average, and/or percentage change 312. This may include multiple different rates for conversion rate 306 and/or patterns or trends in 7-day moving average 308, 7-day weighted moving average, and/or percentage change 312. When setting these trigger conditions, a single smart contract may be generated for the different trigger conditions, where each trigger condition may be sequentially or progressively executed. This may be for the entire amount based on a first met trigger condition or may instead be executed for individual portions of a total amount of funds. Further, multiple smart contracts may instead be generated, each for a trigger condition and/or individual portion of the total funds. In order to resolve multiple smart contracts from multiple users more efficiently, the same or similar smart contracts may be combined from different users based on matching trigger conditions. If met, those may be executed with reduced computing operations and data processing in order to provide faster and more efficient transaction processing.

FIG. 3B is exemplary chart 300b of a weighted moving average over a time period for threshold trigger conditions used to execute a smart contract, according to an embodiment. Chart 300b may represent additional data used for trigger conditions for smart contract execution for currency exchange transactions. Such data may be used when generating and monitoring a smart contract, such as when computing device 110 interacts with distributed network participants and/or transaction processor 130 discussed in reference to system 100 of FIG. 1.

Chart 300b shows a 7-day weighted moving average 320 having a graph 322 that shows an upward trend 324 in 7-day weighted moving average 320 and a downward trend 326 in 7-day weighted moving average 320. In this regard, graph 322 may be used to predict a future exchange rate based on trends in 7-day weighted moving average 320 from graph 322. For example, upward trend 324 may be used to increase a trigger condition for an exchange rate value based on that trend in 7-day weighted moving average 320. A user may establish this preference, or a service provider may use an intelligent analysis and one or more conditions or guarantees in order to increase the exchange rate's value for the trigger condition. However, in response to downward trend 326 in 7-day weighted moving average 320, a corresponding exchange rate value for a trigger condition may be decreased and/or changed. This may occur after increasing the exchange rate's value based on upward trend 324, or may be done separately, such as when approaching an expiration of a wait time in order to receive a higher and/or more favorable exchange rate value for the smart contract's execution.

FIG. 3C is exemplary chart 300c of a percentage change with respect to a previous day over a time period for threshold trigger conditions used to execute a smart contract, according to an embodiment. Chart 300c may represent additional data used for trigger conditions for smart contract execution for currency exchange transactions. Such data may be used when generating and monitoring a smart contract, such as when computing device 110 interacts with distributed network participants and/or transaction processor 130 discussed in reference to system 100 of FIG. 1.

Chart 300c shows a percentage change 330 in an exchange rate value over a previous time period, such as over the previous day. Chart 300c includes a graph 332 that shows a downward trend 334 in percentage change 330, followed by an upward trend 336 in percentage change 330. Similar to chart 300b, graph 332 may be used to predict a future exchange rate based on trends in percentage change 330 from graph 332. For example, in response to downward trend 334 and/or downward trend 334 hitting a certain percentage change (e.g., 5% or greater), another trigger condition may be met in order to execute the corresponding smart contract to receive a more favorable exchange rate and/or avoid further percentage losses in exchange rate value. This may also include lowering a trigger condition's exchange rate during or after downward trend 334. Further, upward trend 336 may be used to determine whether to increase an exchange rate value, revert the exchange rate value if previously adjusted downward based on downward trend 334, and/or automatically execute the smart contract at a higher exchange rate value in response to the increase of percentage change 330 for the exchange rate.

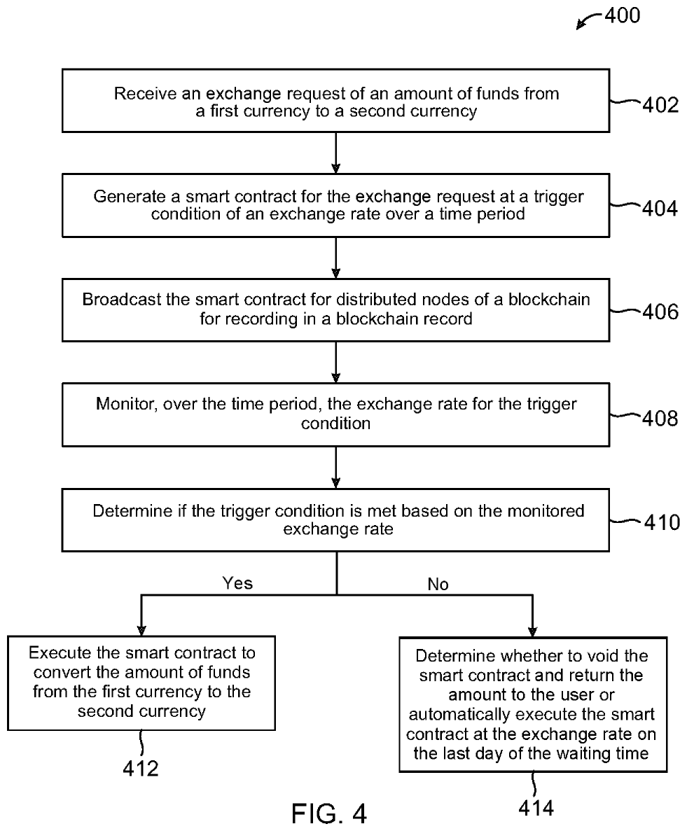

FIG. 4 is a flowchart 400 for dynamic execution of distributed records based on trigger conditions, according to an embodiment. Note that one or more steps, processes, and methods described herein of flowchart 400 may be omitted, performed in a different sequence, or combined as desired or appropriate.

At step 402 of flowchart 400, an exchange request of an amount of funds from a first currency to a second currency is received. The exchange request may correspond to a remittance request for a user to receive back an amount of funds in a different currency than the user funds current currency. In other embodiments, the exchange request may correspond to a checkout, sales, or payment request for a transaction or a payment to another user, where the sender provides the funds in one currency and the funds are to be converted and provided to the recipient in another currency. Further, the exchange request may include smart contract and/or currency exchange transaction parameters, such as a requested exchange rate, a wait time during which the exchange rate between the currencies in monitored to determine whether to convert the funds, exchange rate trends, and/or other information necessary for executing, voiding, and/or recreating one or more smart contracts.

At step 404, the smart contracted is generated for the exchange request at a trigger condition of an exchange rate over a time period. The trigger condition may correspond to the rate, value, or the like of the exchange rate necessary to be met or exceeded for conversion of funds between two currencies or more (e.g., from USD to Euros and Pound sterling). However, more complex trigger conditions may also or instead be established, such as patterns, changes, trends, and/or percentage movements in the value of the exchange rate over time and/or as compared to another time period, exchange rate, or other value. The time period may correspond to a wait time for the smart contract where the smart contract is valid and monitored during the time period and after which the smart contract expires, and another action is taken with the amount of funds provided for conversion between the currencies. In various embodiments, more than one smart contract may be generated, which may correspond to different portions of the amount of funds that are to be exchanged at different trigger conditions.

Prior to or when generating the smart contract, the user may be required to be authenticated so that the smart contract may be validly generated. This may allow the smart contract to be validated and the amount of funds obtained for the smart contract. The smart contract may therefore include a guarantee by the service provider creating and broadcasting the smart contract on the blockchain that the user has been authenticated and the smart contract is valid (including guaranteeing the amount of funds). However, in order to protect user privacy, the smart contract may not include data for the user directly and may use a separate identifier and/or token that obfuscates or hides the identity of the user. The smart contract may otherwise hide or tokenize user data with the smart contract when generated and/or broadcasted in order to retain the privacy of the user.

At step 406, the smart contract is broadcast for distributed nodes of a blockchain for recording in a blockchain record. The smart contract may be broadcast or otherwise transmitted to computing nodes that are distributed over a blockchain and/or payment network, where the computing nodes maintain, update, verify and make available data for the blockchain. The blockchain may therefore include a distributed and/or decentralized digital ledger that includes different block or records that record data including the smart contracts. The distributed nodes may maintain and verify those records to protect from changes and further allow for additional applications, operations, and/or service providers to monitor the records (e.g., the smart contracts) for determination of whether to execute those smart contracts. Further, smart contracts on the blockchain may be monitored together and/or executed together based on similar or matching data. For example, those smart contracts that include a specific exchange rate as a trigger condition may be monitored and executed collectively for more efficient processing and conservation of computing resources.

At step 408, the exchange rate is monitored, over the time period, for the trigger condition. Monitoring of the exchange rate may work in conjunction with the blockchain and smart contracts recorded in the blockchain. For example, a blockchain oracle, such as a secure middleware application, may be used to push data to the blockchain and/or monitoring operations for the exchange rate and smart contracts, as well as pull data from one or more live exchanges. The blockchain oracle may be used as blockchains may not have functionality to push or pull data from external resources as they function as an isolated network of the distributed computing nodes. Instead, the blockchain oracle may correspond to a system that may operate on and off-chain simultaneously in order to facilitate communications between the blockchain and the external live exchange system.

At step 410, it is determined if the trigger condition is met based on the monitored exchange rate. This determination may be based on the exchange rate meeting or exceeding a certain value, percentage conversion, or other rate. However, additional trigger conditions may also depend on trends, changes, or patterns in exchange rates, as well as a remaining amount of time until expiration of the established time period. Thus, if it is determined that the trigger condition is met, at step 412, the smart contract is executed to convert the amount of funds from the first currency to the second currency. Executing the smart contract may correspond to processing a currency exchange transaction that converts the amount of funds from the first currency to the second currency and releasing the amount of funds in that second currency to the recipient of the funds (e.g., the original user for a remittance or a seller, recipient, or the like for a payment).

After the smart contract is executed, the smart contract may be marked as executed, voided, and/or otherwise completed so that the corresponding blockchain is updated with a record for the execution of the smart contract. This may be used so that the blockchain oracle no longer monitors the smart contract's exchange rate for contract execution. However, if at step 410, the trigger condition is not met, then at step 414 it is determined whether to void the smart contract and return the amount to the user or automatically execute the smart contract at the exchange rate on the last day of the waiting time (e.g., for the smart contract). Voiding the smart contract may correspond to ending the smart contract without processing an exchange of the amount of funds to the target currency. This may include returning the amount of funds to the remittance recipient, the original buyer or sender in a payment (such that the transaction is not finalized and/or processed), and/or the seller or recipient (such that the seller or recipient receives the funds, but in the base currency provided by the buyer or sender of the payment). Where the contract is automatically executed, the current conversion rate at the last day or other final waiting time for the smart contract (e.g., a current rate determined at a time of ending the smart contract) may be used to process a currency exchange transaction to convert the amount of funds to the target currency and disperse accordingly.

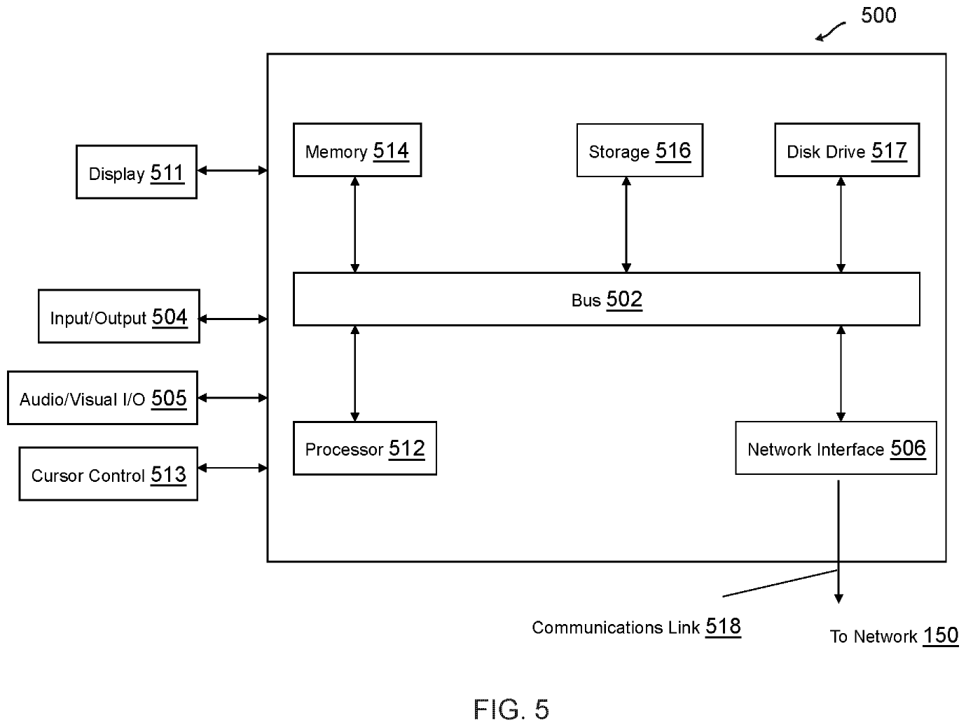

FIG. 5 is a block diagram of a computer system 500 suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, images, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output (I/O) component 505 may also be included to allow a user to use voice for inputting information by converting audio signals and/or input or record images/videos by capturing visual data of scenes having objects. Audio/visual I/O component 505 may allow the user to hear audio and view images/video including projections of such images/video. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. For example, while the description focuses on gift cards, other types of funding sources that can be used to fund a transaction and provide additional value for their purchase are also within the scope of various embodiments of the invention. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
accessing a blockchain comprising a distributed digital ledger for a plurality of smart contracts;
determining a first smart contract of the plurality of smart contracts;
determining a trigger condition for an electronic transaction to be executed based on the first smart contract, wherein the trigger condition comprises a first requested value of an exchange rate of a first currency to a second currency;
determining a wait time for the first smart contract, wherein the wait time comprises a time period until the first smart contract is executed for the exchange rate or voided; and
monitoring, over the time period for the wait time, the exchange rate for the trigger condition of the first requested value of the exchange rate.

2. The system of claim 1, wherein the monitoring uses a blockchain middleware application in communication with a live currency exchange and wherein the operations further comprise:
determining whether the exchange rate meets or exceeds the first requested value during the time period based on the monitoring by the blockchain middleware application.

3. The system of claim 2, wherein the blockchain middleware application monitors the exchange rate with the live currency exchange by pulling data from an external system for the live currency exchange and pushing the data to the distributed digital ledger for the blockchain.

4. The system of claim 2, wherein the blockchain middleware application comprises secure blockchain operations comprising an on-chain component and an off-chain component operating simultaneously to establish a blockchain connection to the blockchain and send the blockchain data to at least the live currency exchange.

5. The system of claim 1, wherein the first smart contract comprises a digital remittance smart contract for a conversion of a first amount of funds in the first currency to a second amount of funds in the second currency based on the exchange rate.

6. The system of claim 1, wherein the first smart contract comprises a digital checkout smart contract for a purchase by a first user, and wherein the digital checkout smart contract requests a conversion of a first amount of funds in the first currency paid by the electronic purchase transaction to second entity to a second amount of funds in the second currency based on the exchange rate.

7. The system of claim 6, wherein the purchase comprises a cross-border transaction between the first user and the one of the second entity.

8. The system of claim 1, wherein the first smart contract comprises one of at least two smart contracts, and wherein a second smart contract of the at least two smart contracts comprises a second requested value of the exchange rate of the first currency to the second currency.

9. The system of claim 8, wherein the first smart contract and the second smart contract are progressively executed based on the first request value and the second requested value for respective portions of an amount paid to a user or a merchant in the second currency.

10. The system of claim 1, wherein the first requested value comprises a variable requested value predicted based on a weighted moving average of the exchange rate.

11. A method comprising:
receiving a smart contract for a blockchain comprising a distributed digital ledger for a plurality of smart contracts;
determining, based on the smart contract, a trigger value of an exchange rate for converting a first currency to a second currency and a validity time period for the smart contract, wherein the trigger value causes the smart contract to be executed to convert an amount of funds in the first currency to the second currency, and wherein the validity time period comprises an amount of time until the smart contract is automatically executed at the exchange rate on an expiration of the amount of time or voided at the expiration of the amount of time;
broadcasting the smart contract to a plurality of distributed computing nodes of the blockchain for the distributed digital ledger; and
monitoring, over the validity time period, the exchange rate for the trigger value of the smart contract using a secure middleware application for the blockchain.

12. The method of claim 11, further comprising:
identifying a negative trend in values of the exchange rate during the validity time period; and
alerting a user associated with the smart contract based on the negative trend.

13. The method of claim 12, further comprising:
automatically executing the smart contract for a conversion of the amount of funds for a current value of the exchange rate based on the negative trend, wherein the current value is different than the trigger value.

14. The method of claim 11, further comprising:
identifying a positive trend in values of the exchange rate during the validity time period; and
determining whether to increase the trigger value or automatically execute the smart contract for a conversion of the amount of funds for a current value of the exchange rate based on the positive trend.

15. The method of claim 14, further comprising:
identifying a negative trend in the values of the exchange rate during the validity time period after the positive trend; and
automatically executing the smart contract for the conversion of the amount of funds for the current value of the exchange rate based on the negative trend following the positive trend.

16. The method of claim 15, wherein the positive trend and the negative trend are based on percentage increases or percentage decreases of the value of the exchange rate.

17. A non-transitory machine-readable medium having stored thereon machine-readable instructions executable to cause a machine to perform operations comprising:
receiving a request to generate a smart contract for a blockchain comprising a distributed digital ledger for a plurality of smart contracts, wherein the request comprises a trigger value of an exchange rate for a first currency to be exchanged to a second currency, and wherein the request further comprises an amount of funds to be exchanged based on the trigger value of the exchange rate and an expiration time of the smart contract;
generating the smart contract in a blockchain record of the distributed digital ledger for the blockchain based on the request, wherein the smart contract comprises at least the trigger value of the exchange rate for the amount of funds and the expiration time, wherein the expiration time causes the smart contract to be automatically executed on an expiration of the expiration time or the smart contract to be voided on the expiration of the expiration time; and
monitoring, prior to the expiration time, the exchange rate for the trigger value of the smart contract using a secure middleware application for the blockchain.

18. The non-transitory machine-readable medium of claim 17, wherein the smart contract comprises a request to convert the amount of funds from the first currency to the second currency for a user.

19. The non-transitory machine-readable medium of claim 17, wherein the smart contract comprises a request to pay the amount of funds from a first user in the first currency to a second user in the second currency for a cross-border transaction between the first user and the second user.

20. The non-transitory machine-readable medium of claim 17, wherein prior to the monitoring, the operations further comprise:
broadcasting the smart contract to a plurality of distributed computing nodes of the blockchain for the distributed digital ledger.
